(19) United States
(12) Patent Application Publication
(10) Pub. No.: US 2003/0142821 A1
(43) Pub. Date: Jul. 31, 2003

(54) Cryptographic one time pad technique

(76) Inventor: David Marshall Ross, Rosburg, WA (US)

Correspondence Address: DAVID M. ROSS, 31 SEAL RIVER ROAD, ROSBURG, WA, 98643, US

(21) Appl. No.: 10/039,429

(22) Filed: Jan. 2, 2002

(51) Int. Cl. H04L 9/00

(52) U.S. Cl. 380/46

(57) ABSTRACT

A variant on the ‘One Time Pad’ cipher is used to provide an encrypted link between two or more stations. The main feature of this variant is the use of a unique and easily created Pseudo-Random Number Sequence segment not having any internal repeats. At one station, a mixing function is used to combine a locally created stream of truly random bytes with a portion of this unique PRNS segment, yielding a fresh stream of truly random data. This freshly created stream of truly random data is operated on in such a way as to create a new and unique PRNS element set which is used to control the functioning of a PRNS generator. The PRNS generator is used to create a new and unique PRNS segment which has a repeat period much longer than the length of the PRNS element set used to create it. It is then useful to treat the PRNS element set as a message and transfer it across the encrypted link to other stations. In this fashion, this OTP cipher variant can be re-keyed and used for as long as there is a continuing source of truly random data available at one of the stations on the network. This technique of using unique and freshly created PRNS segments rather than the classic One Time Pad allows encrypted networks to function independently of any central key distribution regimens or Public Key Infrastructures, making such an encrypted network proof against security breaches perpetrated upon, or key escrow schemes propagated through, such external key distribution infrastructures. This technique also provides certain securities against willful betrayals by tempted users or coerced revelations by users under duress.

### CROSS-REFERENCES TO RELATED APPLICATIONS

This application is entitled to to the benefit of a Disclosure Document. That document is titled “The DERVISH Cipher System”, and carries a stamp of “jc583 U.S. PTO Jan. 3, 2000”, and also carries a yellow barcoded label stating “Disclosure Document No. 467137.

### STATEMENT REGARDING FEDERALLY SPONSORED RESEARCH

This patent application does not involve any federally sponsored work and no work on the invention was done under government contract or while in government employ.

### REFERENCE TO A CDROM APPENDIX

Software pertinent to this patent application is included here as an appendix in the form of a CD-R CDROM containing both executables and the source code for those executables. All executables use a mix of C++ language code and Pentium assembler code and were created using Microsoft Visual C++ version 5.0 and Microsoft Assembler version 6.15

A directory listing of the CDROM is;

Volume in drive E is USPTO_30914

| | | | | |
|---|---|---|---|---|
| CRYPTASM | <DIR> | 12-30-01 | 12:48p | cryptasm |
| INFLATE | <DIR> | 12-30-01 | 12:48p | inflate |
| KEYSERVE | <DIR> | 12-30-01 | 12:48p | keyserve |
| RAND | <DIR> | 12-30-01 | 12:48p | rand |
| REPEAT2 | <DIR> | 12-30-01 | 12:48p | repeat2 |

| | | | | |
|---|---|---|---|---|
| ROTORS00 RTR | 131,076 | 12-19-01 | 8:15p | rotors00.rtr |
| ROTORS01 RTR | 131,076 | 12-19-01 | 8:16p | rotors01.rtr |
| ROTORS02 RTR | 131,076 | 12-19-01 | 8:17p | rotors02.rtr |
| ROTORS03 RTR | 131,076 | 12-19-01 | 8:18p | rotors03.rtr |
| ROTORS04 RTR | 131,076 | 12-19-01 | 8:19p | rotors04.rtr |
| ROTORS05 RTR | 131,076 | 12-19-01 | 8:20p | rotors05.rtr |
| ROTORS06 RTR | 131,076 | 12-19-01 | 8:20p | rotors06.rtr |
| ROTORS07 RTR | 131,076 | 12-19-01 | 8:21p | rotors07.rtr |
| ROTORS08 RTR | 131,076 | 12-19-01 | 8:22p | rotors08.rtr |
| ROTORS09 RTR | 131,076 | 12-19-01 | 8:23p | rotors09.rtr |

| | |
|---|---|
| 10 file(s) | 1,310,760 bytes |
| 5 dir(s) | 0 bytes free |

The supplied files are as follows:

CRYPTASM.EXE, a testbed program for encryption and decryption using the cipher system described in this application.

INFLATE.EXE, a program which expands the binary format of the Pseudo-Random Number Sequence element sets created by RAND.EXE into an ASCII format, making them usable as source code in a software development environment.

KEYSERVE.EXE, a program which creates suitable 512 byte keys for use with the cipher system described in this application.

REPEAT2.EXE, a program which, using a specified set of PRNS elements, creates a PRNS segment of a specified length and examines it for repeats.

RAND.EXE, a program which captures truly random data from the commercial digital sound effects system in a PC and, through the methods described in this application, creates unique sets of PRNS elements.

A sequence of 10 PRNS element sets created by RAND.EXE. These files are in the original binary format and carry a prepended checksum.

Both the executable and the pertinent source code for each are in the appropriately named root subdirectory.

### BACKGROUND

1. Field of Invention

This invention relates to the field of cryptography. Specifically, it is an improved version of the ‘One Time Pad’ cipher technique which provides several unique, worthwhile, and unexpected advantages over the classic Vernam OTP scheme.

2. Discussion of Prior Art

The classic One Time Pad (here referred to as an “OTP”) is covered in the original Gilbert S. Vernam patent, U.S. Pat. No. 1,310,719 dated Jul. 22, 1919. It is a well known system and is generally considered to be an unbreakable cipher if properly implemented. It's main disadvantage is that, for every bit of text transmitted over an OTP encrypted link, there must exist one bit of keytext in the form of the ‘One Time Pad’ document itself (here referred to as a “PAD”). If any portion of the PAD is used more than once then the PAD is generally considered to be compromised.

A major limitation with the classic OTP is that it is not possible to re-key the OTP cipher over it's encrypted link, and therefore there must exist outside the OTP encrypted link another secure path for the transfer of the PAD itself. Since, when using the classic Vernam OTP scheme, the PAD document used in encryption and in decryption is at least as large as the text being encrypted or decrypted, it is not useful to transfer a new PAD document across the encrypted link. The transfer of the new PAD across the encrypted link would use up exactly as much of the old PAD as is provided by the newly transferred PAD.

### SUMMARY

In place of the shared block of fixed keytext used as a PAD in the classical OTP, this invention uses a Pseudo-Random Number Sequence (here referred to as a “PRNS”) generator having both a long sequence length and also a high degree of randomness and unpredictability. The elements used to create this PRNS are shared by both the sending (encrypting) and receiving (decrypting) stations, and are used by both stations to create a non-repeating PAD.

The elements comprising this PRNS generator will create a non-repeating PRNS segment which is longer than the size of the elements. It is therefore worthwhile to transfer a new set of PRNS elements over an existing encrypted network using an existing set of PRNS elements. This allows an encrypted network to be rekeyed using the existing network and does not require the use of a separate secure path for PAD distribution.

A novel and unexpected feature of this invention is that any node on the encrypted network can create new and usable PRNS elements if it has access to a continuous stream of truly random data. This truly random data is combined with the output of a dedicated PRNS generator and the fresh random data from this combination is operated on and rearranged and condensed in such a way as to create a new and unique element set for the PRNS generator. Further, any node on the network can send these new and unique PRNS element sets over the network in encrypted form. These new sets of PRNS elements can then be used to replace existing PRNS elements in other network nodes, thereby rekeying the entire network.

Another novel and unexpected feature of this invention is that this ‘key distribution’ scheme eliminates the need for centralized key servers or public key infrastructures. Eliminating centralized key servers and public key infrastructures makes the network proof against any security breaches perpetrated upon, or key escrow schemes propagated through, those key distribution servers and PKIs.

In this way it is possible that an encrypted network can be entirely self-sufficient and not depend on any outside infrastructure for key distribution, other than the initial distribution of a single set of PRNS elements either at the time the network is created or at the time a new node is added to the network. Other novel and unexpected benefits accrue from this architecture, such as:

Since the set of PRNS elements is impossibly long for memorization (over 130 KBytes in this implementation) many security holes are nonexistent, such as the inadvertent leaking of passwords or passphrases by users and also the revelation of a password or passphrase when subject to temptation or while under duress.

Given the size and fixed format and fixed length of a set of PRNS elements, the unauthorized transmission of that set of PRNS elements across a network may be more easily monitored and detected than the unauthorized transmission of a simple password or passphrase of unknown format and length.

Objects & Advantages:

A truly secure OTP has tight requirements for keytext unpredictability and uniqueness and nonrepeatability. PRNS generators exist which can produce suitable PRNS segments, and we substitute the output of such a PRNS generator for the original fixed PAD as used in a true Vernam OTP cipher.

If one chooses to use the ‘absolute security’ of a true Vernam OTP, he is faced with the dilemma of how to create the huge amounts of random and unpredictable data which a large-scale OTP system will require. The success of the NSA's “VENONA” project in cracking the Russian OTP traffic of the early Cold War era is testimony to the disasters which can result from failing to provide adequate PADs. The term ‘randomness’ is a fuzzy one and the concept is very difficult to quantify, but PRNS generators exist which can provide PRNS segments of limited lengths which will, by any measure, provide randomness and unpredictability equal to that of ‘truly random’ number sources.

The PRNS generator currently used here has keying elements of size 131072 bytes (2\hat{ }17 bytes), and the PRNS generator using those elements can produce a provably non-repeating PRNS with a length of over 4 gigabytes (2\hat{ }32 bytes). A major advantage of this invention is that, with this technique, the entire encrypted network can be rekeyed by sending PRNS element sets over the encrypted link. The PRNS generator used here allows the transfer of 4 gigabytes of ciphertext over an encrypted network with the transfer of only 128 KBytes of PRNS elements, a ratio of 32768 ciphertext bytes to 1 byte of PRNS elements.

With this invention, it is possible that any user with access to a truly random data source can create fresh and unique PRNS keying element sets for the PRNS generator. End users can create their own PRNS element sets and distribute them as traffic over the encrypted network. That truly random data could come from one of, or a combination of, any number of sources:

an optical sensor which senses the changing patterns of clouds in the sky

an optical sensor which senses the changing patterns of two immiscible fluids in a transparent container which is heated by an electrical apparatus

an analog-to-digital converter which digitizes the intermodulation distortion produced by an FM radio receiver tuned to a point where it can receive & attempt to demodulate the simultaneous signals from two different FM radio broadcast stations transmitting on adjacent frequency channels.

It is possible that a given station on the encrypted network can retain multiple sets of PRNS elements. This enables a single station to be included in multiple and separate and independent encrypted networks operating over the same medium.

It is possible that a given user can create new and separate and independent encrypted networks, by first distributing an initial set of fresh and unique PRNS elements over a separate and secure link and then later sustain that new encrypted network by distributing fresh and unique PRNS element sets via the new encrypted network.

It is possible that a given PRNS element set can be used to create multiple and independent PRNSs, so that a number of users could carry on a secure correspondence using only a single set of PRNS elements.

It is possible that, using a single PRNS element set to create multiple PRNS segments, a logically central network node could correspond with multiple other nodes on an encrypted network with each non-central node being unable to decrypt traffic to or from any other non-central node.

It is possible that several separate and distinct encrypted networks can exist using the same medium and that these separate and distinct encrypted networks can be mutually secure and non-interoperable, given the use of PRNS element sets and PRNS generators of differing formats. In this case, a plaintext packet header on an encrypted packet transiting the network might carry an identifier which would specify which PRNS generator format and which PRNS element set format should be used to decrypt the message.

It is possible that different PRNS generator schemes and formats could exist, such that one user may operate with a certain version of software and that that particular software version would require a certain unique format of PRNS elements. That particular set of PRNS elements may not be compatible with other PRNS generators, so that even in the event that a PRNS element set be lost or compromised, that single event would not be catastrophic for all members of all encrypted networks.

In this OTP variant cipher, sets of PRNS elements are considered to be disposable in the same sense that the PAD in a classical OTP system is considered disposable. Once a classic Vernam PAD has been completely used, it must not be reused and will likely be destroyed for the sake of the security of existing encrypted messages. In the OTP variant cipher described here, once the PRNS generator has created a given amount of PAD keytext from a given PRNS element set, a new PRNS element set is installed in the PRNS generator and the old PRNS element set can be destroyed.

In the original Vernam OTP system, once all copies of a PAD are destroyed it is no longer possible to recover plaintext from existing ciphertext, and that same principle applies here. Once all copies of a given set of PRNS elements are destroyed, it is no longer possible to decrypt ciphertext created by a PRNS generator which used that particular PRNS element set.

For a true Vernam cipher it is necessary that the PAD never repeat. The same holds true for this OTP variant scheme, in that the PRNS generator must never create a repeating sequence within that PRNS segment which is used as a PAD. It may be possible that some PRNS generators can be trusted to not repeat over a certain restricted range of PRNS segment sizes, or it may be necessary to individually examine a given PRNS segment in order to be certain that the particular PRNS generator has not created repeats in the given PRNS segment.

The technique of passing PRNS elements over an existing and established encrypted network has obvious advantages in it's own right, but this PRNS technique is also useful when first establishing the encrypted network. When starting up a new network, neither the classic Vernam PAD nor the initial PRNS element set can be sent out across an unencrypted network as plaintext, since any eavesdropper who intercepted the PAD or PRNS elements would then have access to any encrypted traffic on the network. However the use of PRNS elements in place of the classic Vernam PAD does have the advantage of drastically reducing the amount of data necessary to start up a fresh encrypted network. Given the 131072 byte size of the PRNS element set used in this implementation it is possible to put 11 complete sets of PRNS elements on a single 3.5″ floppy disk, whereas data from the 2\hat{ }32 byte PRNS generated by a single one of those 11 PRNS element sets would occupy over 2900 of the same 3.5″ floppy disks.

Given the advantage that only a relatively small data file must be distributed in order to provide the PRNS element set necessary to start up a new encrypted network, the task of distributing that PRNS element set to the network's nodes or members becomes much simpler. It can easily be accomplished by handing out a single CDROM at a board meeting or a workgroup meeting or a family holiday dinner or a school class meeting or a military briefing or at a government worker's retreat.

Regarding the delivery of PRNS element sets via the postal system. Certainly the possibility exists of the surreptitious reading of the PRNS element set while it is in anonymous transit, but with a few precautions it may be possible to guard against security breaches. Obviously if the envelope containing the PRNS elements diskette has been opened or tampered with, then the enclosed PRNS elements must be considered to be compromised and should certainly not be used for anything other than spoofing possible eavesdroppers with bogus encrypted traffic.

There exist many styles of ‘tamper-evident’ adhesive tapes which can be used to seal an envelope, and these tapes will provide immediate evidence that an envelope has been opened while in transit.

It is an open question whether or not technologies exist which can read the data from a floppy disk or a CDROM while it is sealed in a mailing envelope, but it is a good guess that any of those techniques would, in reading the information, also destroy the information. It is clear that an anonymous delivery technique such as the U.S. Mail may not be the preferred and optimal delivery method for PRNS element sets, but it may be suitable for certain applications, depending on the paranoia level of the individuals involved.

### DESCRIPTION OF DRAWINGS

FIG. 1—A flow chart describing the creation of a PRNS element set.

FIG. 2—A diagram of the message encryption process

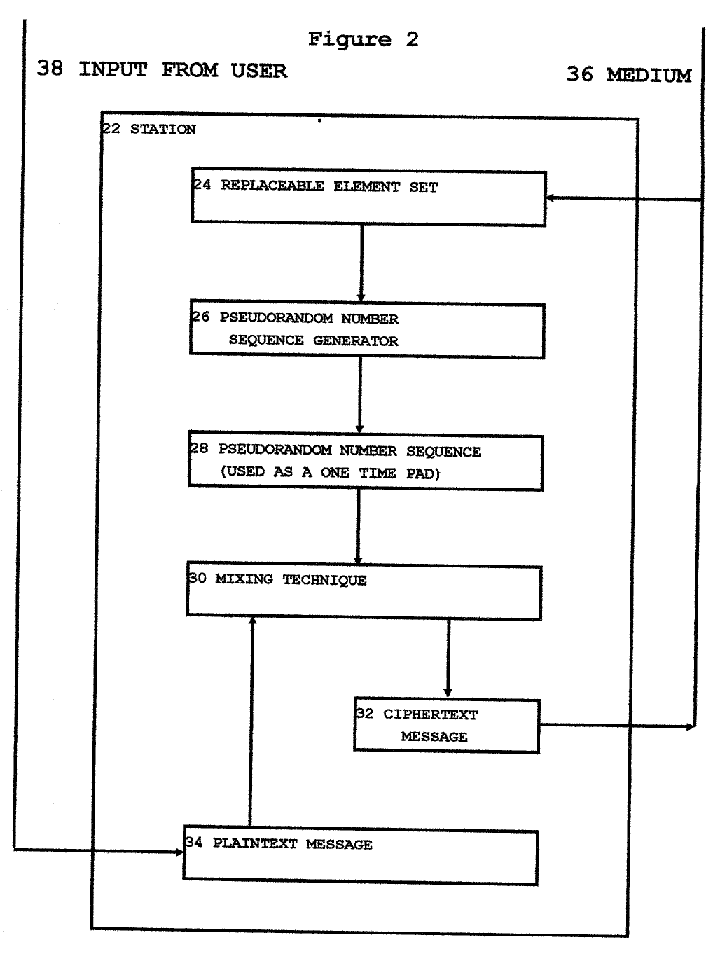

FIG. 3—A diagram of the message decryption process

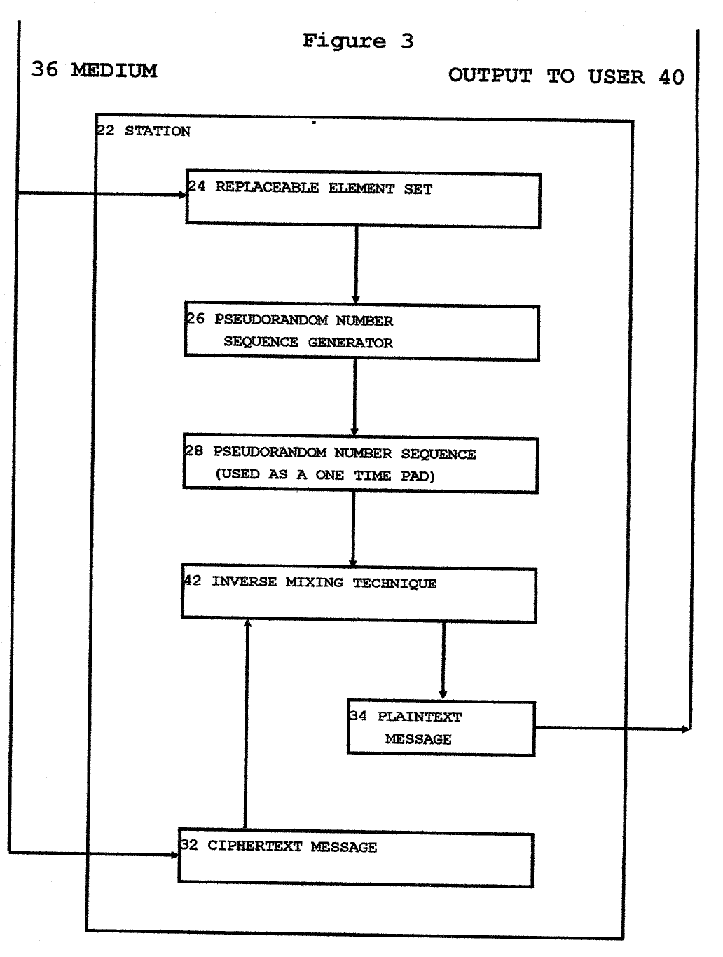

FIG. 4—A diagram of the PRNS element set creation process

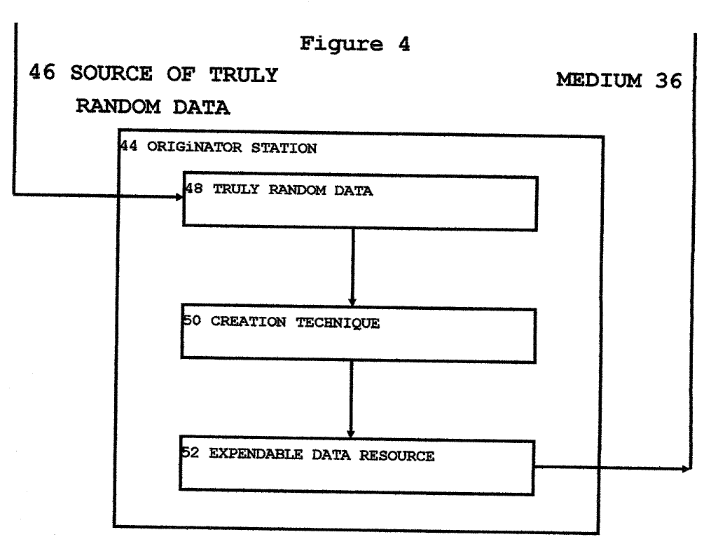

### LIST OF REFERENCE NUMERALS

22—station

24—replaceable element set

26—pseudorandom number sequence generator

28—pseudorandom number sequence

30—mixing technique

32—ciphertext message

34—plaintext message

36—medium

38—input from user

40—output to user

42—inverse mixing technique

44—originator station

46—source of truly random data

48—truly random data

50—creation technique

52—expendable data resource

### DESCRIPTION OF INVENTION

The invention will be described here first as a set of separate logical elements, then a description will be provided of the invention as a whole. The separate logical elements are as follows:

A. Description of a possible implementation of the PRNS generator.

B. Description of a possible implementation of a key generator for use in the implementation of the PRNS generator described in 1. above.

C. Description of a possible technique for the creation of a set of new and unique set of PRNS elements for use in the implementation of the PRNS generator described in 1. above.

D. Description of a possible implementation of message encipherment.

E. Description of a possible implementation of message decipherment which is interoperable with the encipherment technique described in D. above.

F. Description of a possible implementation of a technique used to transfer PRNS elements from one network station to another network station.

Each station on the encrypted network may consist of a conventional Personal Computer (here referred to as a PC).

Description of Possible Implementations of the PRNS Generator:

A description of one possible implementation of the PRNS generator is this. What is referred to here as ‘a PRNS element set’ consists of 512 contiguous but separate and independent arrays of data, with each array being 256 bytes in length and consisting of one each of each of the 256 possible byte values, all placed in a random order. In this implementation, these 512 contiguous arrays comprise the ‘PRNS element set’ as mentioned above. The PRNS element set has a length of 131072 bytes.

In addition to the 131072 bytes of PRNS elements, there also exists another array of 512 bytes called the WINDOW, with each single byte of this 512 byte serving as a pointer into one of the 512 contiguous but separate 256 byte arrays comprising the 131072 byte set of PRNS elements.

The data in this 512 byte WINDOW array serves as a starting point for the generation of a PRNS segment. A pertinent portion of the SOFTWARE used to create the PRNS segment is shown below, along with pertinent CPU register names and functions.

Note that this software is specifically coded for execution by a Pentium (Pentium is a registered trademark of the Intel Corporation) CPU, but that the possible PRNS generator algorithm shown here is adaptable to any number of other CPUs.

Also note that the bulk of the PRNS generator routine is left out for the sake of brevity. The entire source code is provided in the CDROM appendix.

The 131072 byte PRNS elements array resides at address ‘rotors’, the 512 byte WINDOW array resides at address ‘window’, and the dword CRC-32 checksum of the PRNS element set resides at address ‘SALT_VALUE’.

| | mov | al,0 |
|---|---|---|
| ;initial value in AL register is zero. | | |
| ;AL is the initial input byte value | | |
| | mov | ebx,0 |
| ;initial value in EBX register must be zero | | |
| | mov | edx, SALT_VALUE |
| ;initial value in EDX in the SALT_VALUE. | | |
| ; | | |
| e000: | mov | bl, [window+000] |
| ;get current WINDOW data byte to BL, | | |
| | xor | al, [ebx+rotors+000*256] |
| ;XOR INPUT BYTE in al register with | | |
| ;selected PRNS elements data | | |
| | xor | bl,dl |
| ;XOR EBX pointer with a portion of current | | |
| ;checksum data in EDX lsb | | |
| | xor | dl, [ebx+rotors+000*256] |
| ;XOR EDX salt LSB with rotors data, | | |
| ;forming altered salt dword | | |
| | rol | edx,1 |
| ;left rotate the SALT_VALUE dword in EDX | | |
| | mov | [window+000],dl |
| ;save WINDOW data from salt in EDX LSB | | |
| ; | | |
| e001: | mov | bl, [window+001] |
| | xor | al, [ebx+rotors+001*256] |
| | xor | bl,dl |
| | xor | dl, [ebx+rotors+001*256] |
| | rol | edx,1 |
| | mov | [window+001],dl |
| ; | | |
| ;a large portion of the PRNS software has | | |
| ; not been shown here. The deleted portions | | |
| ; are identical to the portions shown here, | | |
| ; with the exception of two pointer values. | | |
| ; | | |
| e510: | mov | bl, [window+510] |
| | xor | al, [ebx+rotors+510*256] |
| | xor | bl,dl |
| | xor | dl, [ebx+rotors+510*256] |
| | rol | edx,1 |
| | mov | [window+510],dl |
| ; | | |
| e511: | mov | bl, [window+511] |
| | xor | al, [ebx+rotors+511*256] |
| | xor | bl,dl |
| | xor | dl, [ebx+rotors+511*256] |
| | rol | edx,1 |
| | mov | [window+511],dl |
| ; | | |
| | mov | SALT_VALUE,edx |

;save SALT_VALUE for future use

ret

;PRNS generator output now in AL register
;
;Software Copyright 1998, 1999, 2000, 2001 by David M. Ross
;Complete software listings are in the CDROM appendix
;

This implementation of the PRNS generator is extremely long and would be quite slow in execution. There is an interplay between PRNS generator speed and size and also in the length of PRNS segment produced before a repeat occurs. A smaller PRNS generator will run faster, but since in this OTP application it must produce sequences without internal repeats it will be limited to producing much shorter sequences.

A PRNS generator designed and coded to use only a single array of 256 PRNS elements and single byte in the WINDOWS array would be found to be wholly inadequate for producing the extremely long and unpredictable and nonrepeating PRNS required by this OTP variant cipher. The software excerpted above, having a PRNS elements structure of 512 separate 256 byte arrays has been found to produce nonrepeating PRNS streams so long as to defy my equipment's ability to determine exactly when they do repeat. For this OTP variant cipher application, the software shown above is overkill and is needlessly slow for the application.

It has been found empirically that, using the above software structure, an array of 1536 (6 * 256) bytes of PRNS elements is adequate to consistently produce non-repeating PRNS segments of 2\hat{ }32 (four gigabytes) byte length.

In this OTP variant application it may however be desirable to use a larger set of PRNS elements. Using a larger PRNS element set than is absolutely necessary to produce a non-repeating PRNS segment of a given length is not a waste of time and effort, given that the extra length of the PRNS element set does provide some benefit. In this case the benefit is that of extra security—used properly, the extra entropy provided by the longer PRNS element set will yield a larger field of possible PRNS variations and will lead to a more secure and a less predictable PRNS.

One possible technique to use the extra entropy of a larger set of PRNS elements while still maintaining reasonable PRNS segment creation time is to divide the 131072 byte array of 512 separate but contiguous 256 byte arrays further into smaller logical set of arrays. The single array of 512 arrays is divided further into 64 sets of eight 256 byte arrays. To produce a given byte in the PRNS, rather than using the entire set of 512 arrays, a particular one of the 64 sets of eight arrays is used. For the next byte of the PRNS, a different one of the 64 sets of eight arrays is used. (Which particular one of the 64 possible sets of eight 256 byte arrays that is used may depend on a particular combination of six individual bits in the register carrying the SALT_VALUE dword in the software above.) This ‘segmentation’ technique of using different groups of eight arrays for each byte in the PRNS will provide a PENS of non-repeating length longer than the non-repeating length of a PRNS produced by using a single group of eight arrays, and the new PRNS will carry the benefit of having incorporated in it the additional entropy of the 504 ‘extra’ 256 byte arrays which were used in it's creation,

A second possible technique to use the extra entropy of a larger set of PRNS elements while still maintaining reasonable PRNS creation time is to divide the 131072 byte array of 512 separate but contiguous 256 byte arrays into a different logical set of arrays. The single array of 512 arrays is divided into 32 sets of 16 256 byte arrays. For the creation of a given byte in a PRNS, a given set of 16 256 byte arrays is selected using a technique similar to the one described above, that of using a set of five particular bits from the SALT_VALUE dword to point to one of the 32 groups of 16 256 byte arrays. Each set of 16 256 byte arrays is further divided into a group of nine arrays which are always used, and another group of seven arrays which may possibly be used. For a given byte in the PRNS, from 9 to 16 (inclusive) contiguous arrays from the selected group of 16 256 byte arrays are used. What number of 256 byte arrays are used may again depend on a combination of bits in the SALT_VALUE dword.

B.) Description of a Possible Implementation of a Key Generator

A key generator for the above described PRNS generator has the function of creating a new starting point for the PRNS generator for use with a new set of PRNS elements. For use with the PRNS generator described above, this key generator will produce an unpredictable sequence of 512 bytes of pseudo-random data. That 512 byte sequence will be used as a possible starting point for a PRNS generator, and will appear in MEMORY at a point designated by the pointer ‘window’

To create the key, it is convenient to rely upon a dedicated key generator which has the same structure as the PRNS generator described above. The dedicated key generator has the same structure as the PRNS generator used to create the PRNS segment which is used as a One Time Pad, but uses a PRNS element set which is dedicated strictly to the process of key generation. Doing so will allow the use of a 2\hat{ }32 byte long non-repeating PRNS segment to create 8 million 512 byte keys.

Since new sets of PRNS elements are easily created and are considered disposable, we can reserve a single set of PRNS elements for use strictly for the purpose of key generation. Since this PRNS element set is in format identical to the sets of PRNS elements used to create PADs for the actual enciphering and deciphering operations, we can trust that set of PRNS elements (either through reputation of through testing) to create a non-repeating sequence of over 4 billion (2\hat{ }32) bytes length.

To create a new key, we use the software shown in the software snippet in A.) above. The sequence can be described as follows:

1.) Load the ‘rotors’ pointer with a dword pointer to a set of PRNS elements which we reserve for use only as a key generator,

2.) Load the ‘window’ pointer either with:

a dword pointer to the key which is left over from the previous use of this set of PRNS elements or with:

a dword pointer to the key initially supplied with a fresh set of PRNS elements.

3.) Load the SALT_VALUE dword either with:

the SALT_VALUE which was left over from the previous use of this set of PRNS elements or with:

the checksum value initially supplied with a fresh set of PRNS elements.

4.) Step the PRNS generator a total of 512 times, and after each step save the result (present in the AL register). The resultant 512 bytes are the new key ‘window’ value.

5.) Save the resultant 512 byte ‘window’ string for use in creating the subsequent key.

6.) Save the resultant SALT_VALUE dword for use in creating the subsequent key.

(In the above description, before doing the actual stepping through the PRNS creation, we use previous values for the 512 byte ‘window’ string and also for the dword SALT_VALUE. Obviously previous values for these two items do not exist for the first time that a dedicated set of PRNS elements are used to create a fresh key. The same situation exists when a fresh set of PRNS elements are first used to create the beginning portion of a PRNS which is to be used as a PAD.

In both cases, the initial values for these two items are distributed along with fresh sets of PRNS elements. The 512 byte ‘window’ value is a supplied key which serves as a starting point for the first use of the set of PRNS elements, and the dword SALT_VALUE is a CRC-32 checksum of a concatenation of the ‘window’ string and the actual set of PRNS elements. This mechanism will be covered in greater depth in section C.) below.)

C.) Description of the Creation of a New Set of PRNS Elements

This method of creating a new and unique set of PRNS elements preassumes that three things exist on at least one of the stations on the encrypted network, a.) an existing set of PRNS elements, b.) a technique for generating a random key, and c.) an available stream of truly random data.

The existing set of PRNS elements will be assumed to be unique and different from the set/sets which is/are in use to encrypt and decrypt network traffic.

The technique for generating the random key will be assumed to be the one outlined in B.) above.

The stream of truly random numbers can come from one or from a combination of sources, and the sources may be any valid source of truly random data, including but not limited to:

an optical sensor which senses the changing patterns of clouds in the sky

an optical sensor which senses the changing patterns of two immiscible fluids in a transparent container which is heated by a light bulb

an analog-to-digital converter which digitizes the intermodulation distortion produced by an FM radio receiver tuned to a point where it can receive & attempt to demodulate the simultaneous signals from two different FM radio broadcast stations transmitting on adjacent frequency channels.

In practice here the third technique is used—the source of truly random numbers amounts to a stream of byte values produced by a commercial digital sound effects system in a commercial PC. The sound effects system is fed with a monaural audio signal coming from a commercial FM radio receiver which is tuned to a point between two commercial FM radio broadcast stations. The signal fed to the sound effects system is a distorted composite of the audio from both FM broadcast stations. The combination of:

the intermodulation distortion produced by the presence of two separate signals in the FM radio receiver's detector and

the additive action of the two separate signals themselves serves to produce a stream of byte values which are extremely unlikely to repeat on any scale.

This discussion will assume that the set of PRNS elements to be created are of the same format as discussed in A.) above, namely a 131072 byte array of 512 separate but contiguous 256 byte arrays, with each 256 byte array containing all 256 possible byte values placed in random order.

The incoming stream of truly random numbers is first put through a hash function, which amounts to nothing more than the encryption of the incoming stream of truly random bytes by the encryption software described in A.) above. This is done in order to flatten out any possible uneven distributions of byte values in the stream of digitized bytes coming in from the PC's sound effects system and provide a more uniform byte stream. We assume that this hashed stream of bytes contains an even distribution of every one of the 256 possible byte values, and statistics from the actual PRNS element creation process bear out this assumption more on these statistics below.

The 131072 byte array of 512 separate 256 byte arrays is built up one 256 byte array at a time, and we will examine the process used to create a single 256 byte array. The entire 131072 byte set of PRNS elements is a concatenation of 512 of these 256 byte arrays with a prepended CRC-32 checksum added for identification.

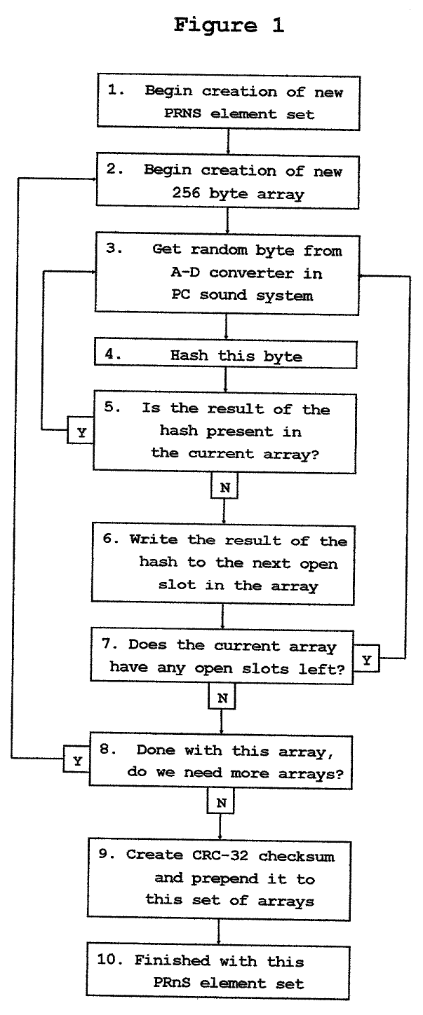

FIG. 1 is a flow chart which describes the creation of an entire PRNS element set.

One single 256 byte array is created in this manner:

1.) Reserve 256 bytes of memory space for the array at address ‘array’.

2.) Reserve 256 bytes of memory space for a table at address ‘table’.

3.) Reserve memory space for a single byte counter at address ‘counter’.

4.) Fill the 256 byte area at ‘table’ with zero bytes.

5.) Fill the byte at ‘counter’ with a zero byte.

6.) After an appropriate delay retrieve the next random byte from the PC sound effects system.

7.) Hash that random byte using the encryption technique in A.) above.

8.) Use the resultant hashed byte as a pointer into ‘table’. If the byte at address (‘table’+‘hashed byte’) is nonzero, then go to step 6.) above and retrieve a new hashed byte, because the value of the current hashed byte is already present in the array.

9.) If the byte at address (‘table’+‘hashed byte’) is zero, then the value of the present hashed byte is not yet present in the array, so write one into the byte at (‘table’+‘hashed byte’), thereby marking that hashed byte as used.

10.) Write the ‘hashed byte’ into the memory address (‘array’+‘counter’).

11.) Increment ‘counter’.

12.) If ‘counter’<256 then go to step 6.).

13.) Exit with newly created 256 byte array at address ‘array’.

The entire 131072 byte set of PRNS elements consists of a concatenation of 512 of the these 256 byte arrays. A prepended CRC-32 checksum will be added. The checksum can be used for identification, and/or can be used as a filename, and/or can be used for error detection in the contents of the PRNS elements, and/or can be used as the initial SALT_VALUE in the encryption and decryption processes detailed in A.) above.

In this implementation of a PRNS generator, sets of PRNS elements have the following format:

1.) bytes 1-4 are a dword CRC-32 checksum of the remainder of the set of PRNS elements.

2.) bytes 5-131076 are the actual PRNS elements, consisting of 512 separate but contiguous arrays of 256 bytes each.

Some notes regarding searching for repeats in PRNSs:

Every PRNS will repeat. Let's examine a very simple binary sequence, specifically that of a four bit decade upcounter. The entirety of the behavior of this four bit counter can be specified in a table of only 2\hat{ }4=16 entries—simple enough to be totally uninteresting, except for one item . . .

The intended function of a decade upcounter is to count from zero to nine, then recycle back to zero and repeat the process. We know that this four bit counter has 16 possible states, but that only ten are used in the counter's intended function of decade counter. The other six states may not be strictly illegal but are considered to be ‘degenerate’. It may be possible to preset the counter's outputs to one of these six states, or it may be possible that the counter could power-up into one of these six degenerate states. If we preset the counter to one of these six states and then clock the counter repeatedly, the results are that the upcounter does act in a deterministic way but may never again reach that same degenerate state regardless of how many times we clock the counter. The counter may pass through one or more of these six degenerate states and then will fall into it's specified repeating PRNS behavior as a decade counter.

It is convenient to describe states in the main 0-9 sequence of the decade upcounter as the being in the ‘loop’ and also convenient to describe the other six degenerate states as occupying a ‘spur’. A loop will always repeat but spurs never repeat. An individual state on a loop will always reoccur, while an individual state on a spur can never reoccur.

The behavior of this four bit counter can be totally specified in a state table of 2\hat{ }4=16 entries. The PRNS generator we are using in this OTP variant has a state defined by the 512 byte ‘window’ string plus the 32 bits of the SALT_VALUE dword. This amounts to 4128 bits, so the state table necessary to describe the behavior of this OTP PENS would have 2\hat{ }4128 entries. The PRNSs used with this OTP variant are complex enough that they will likely have multiple separate loops present in their state table, and they will also likely have multiple spurs feeding each of the multiple separate loops. If we are to search each set of PRNS elements for a possible repeat, we must use a search algorithm which takes this structure into account.

For the sake of example, we will suppose that the 4 gigabyte PRNS segment which we are examining for repeats has the following structure:

1.) Initially, a 3 gigabyte non-repeating spur which feeds:

2.) A 32 byte long loop which repeats 33,554,432 times in the final 1 gigabyte of the PRNS.

If we search the entire 4 gigabyte sequence for a duplicate of the byte sequence occurring at the beginning of the initial 3 gigabyte spur, we will never find any of the repeats in the final 1 gigabyte of the PRNS. The use of this PRNS as an OTP would be catastrophic and a useful repeat search algorithm must find hidden repeating sequences of this sort.

A useful technique for searching the entire PRNS for internal repeats is this:

1.) Define a repeat as a sequence of N bytes which reoccurs anywhere in the PRNS. Here we will use N 16 bytes.

2.) Step through and create the entire 4 gigabyte PRNS segment, and leave the entire PRNS segment in memory.

3.) The final 16 bytes in this PRNS segment is the sequence of bytes which we will search for throughout the entire four gigabyte sequence.

A useful subroutine for doing this 16 byte search is this:

| ; | | |
|---|---|---|
| ;pointer to compare buffer | | |
| | mov | esi,offset PAD |
| ;funny start here... | | |
| | dec | esi |
| ; | | |
| ;get compare bytes previously | | |
| ;gathered from the 16 bytes just | | |
| ;at the end of the 4 gigabyte | | |
| ;PRNS segment | | |
| | mov | eax,save_eax |
| | mov | ebx,save_ebx |
| | mov | ecx,save_ecx |
| | mov | edx,save_edx |
| ; | | |
| rpt: | inc | esi |

;point to next byte in PRNS segment

| | |
|---|---|
| cmp | eax, [esi] |

;compare next dword in the sequence

| | |
|---|---|
| jnz | rpt |

;loop if no valid compare
;

| | |
|---|---|
| cmp | ebx, [esi+4] |

;compare next dword of the sequence

| | |
|---|---|
| jnz | rpt |

;bad compare so continue the loop...

| | |
|---|---|
| cmp | ecx, [esi+8] |

;compare next dword of the sequence

| | |
|---|---|
| jnz | rpt |

;bad compare so continue the loop...

| | |
|---|---|
| cmp | edx, [esi+12] |

;compare next dword of the sequence

| | |
|---|---|
| jnz | rpt |

;bad compare so continue the loop...
;

| | |
|---|---|
| cmp | esi,PRNS_end |

;are we at the end of the PRNS?

| | |
|---|---|
| jz | no_compare_exit |

;yes, so it contains no repeats...

| | |
|---|---|
| jmp | yes_compare exit |

;no, so we did find a 16 byte repeat
;
;Software Copyright 1998, 1999, 2000, 2001 by David M. Ross
;Complete software listings are in the CDROM appendix
;

The above routine will search for a 16 byte repeating sequence and will ignore shorter repeating sequences. It is quite fast—note that this routine has just three instructions in the basic compare loop. Note also that the basic compare loop does not check for arrival at the end of the portion of the PRNS segment in memory. To accommodate this, it is necessary to provide the correct searched-for 16 byte sequence at the end of the portion of the PRNS segment in memory. The last three instructions in this code snippet allow the CPU to decide if it has found a ‘real’ 16 byte repeat inside the PRNS segment, or if it has merely encountered the 16 byte sequence occurring at the end of the PRNS segment and placed there entirely for the sake of delineating the end of the PRNS segment in memory.

A note regarding the creation of multiple PRNSs from a single set of PRNS elements. It is possible to specify different starting points (window values) and thereby create different PRNS segments from a single PRNS element set. It is necessary that none of the resulting PRNS segments share any loop or spur segments with any other PRNS segment. This is not difficult to test for but can be time consuming. The above code snippet is useful here. Assume that we have created three separate 4 gigabyte PRNS segments and further have tested each one and determined that each one of the three does not have any internal repeats (three comparison scans involved already). We wish to now determine if any of the three PRNS segments overlap with any other segments—this must be avoided because it could lead to an effective repeat, i.e. multiple plaintexts being encrypted with identical portions of the PAD. To verify non-overlap of multiple PRNS segments (here numbered 1 and 2 and 3), we:

search PRNS segments 2 and 3 for valid compares with the last 16 bytes of segment 1 (2 scans)

search PRNS segments 1 and 3 for valid compares with the last 16 bytes of segment 2 (2 scans)

search PRNS segments 1 and 2 for valid compares with the last 16 bytes of segment 3 (2 scans)

The actual compare code listed above amounts to a loop of three instructions comprising five bytes of code, so it runs quite quickly provided that all PRNS segments are still available in memory and do not have to be re-created in order to do the comparison. For N PRNS segments we see that a complete scan for both internal repeats and external overlaps requires N\hat{ }2 total comparison scans through the PRNS segments—this example of three PRNS segments requires nine comparison scans and a set of 10 PRNS segments would require 100 comparison scans.

Several notes regarding the use of digitized radio signals as a source of random numbers:

1.) It is likely that simply tuning the commercial FM receiver to an unused frequency (a frequency between audible broadcast stations) and digitizing the result will produce a data stream that is highly deterministic and also one that is likely to have many partial repeats and many short repeating sequences. The hiss which one hears from a commercial FM receiver tuned thus is mostly produced in the detector in the FM receiver. Note that the audible signal you hear on an unused FM radio channel does not change appreciably when you disconnect the antenna from the receiver.

2.) It is best to not use an interrupt-driven method of generating the timing of the digitization. Using CPU interrupts would provide a strict timing regimen for the digitization commands and could possibly yield a very deterministic output data stream under certain signal conditions. If the signal from the commercial FM broadcast receiver were to be digitized at a precisely controlled rate, then it is possible that signals of constant frequency (i.e. test tones from the radio transmitter site or Emergency Alert Signal tone pairs or certain bizarre music structures) could produce a more deterministic byte stream and one more likely to have partial repeats or short repeating sequences.

3.) It is possible to cause the digitizer in the PC's sound effects system to sample the incoming audio signal at differing rates. Using too fast a sampling rate will also produce a data stream that is highly deterministic and also one that is likely to have many partial repeats and many short repeating sequences. When successive digitized samples of the incoming waveform occur too quickly, those samples can represent a very short and very deterministic portion of the waveform coming in from the radio receiver and are more likely to produce repeats. Given an FM receiver having an upper end frequency response of 20 KHz, one could theoretically sample the resultant output of the receiver at a rate of 40 Ksamples/second and have hope for a non-deterministic stream of digitized data. Sampling as fast as this may not be useful or necessary, because the actual creation of the set of PRNS elements occupies only a short time compared to the time required to test the PRNS segment produced by that PRNS element set for a possible repeat. Gathering the number of samples necessary to create a complete set of PRNS elements requires less than a minute with a sampling rate of approximately 12.5 Ksamples/second, but even on the fastest PC tested thus far the creation of the resulting 4 gigabyte PRNS and the search for a repeat in that PRNS requires over 15 minutes.

Regarding the number of samples required to create a set of PRNS elements. The theoretical number required is easily calculable and closely matches actual results. For the first sample of a 256 byte array, any sample is acceptable because there are no previous samples in memory which would cause the rejection of the current sample. The second sample has a one in 256 chance of being rejected as a duplicate, and so will on the average require 256/255 samples in order to find an appropriate byte. The third will require 256/254 samples on the average and so on down to the 255th sample which will require 256/2 samples in order to find an appropriate byte. We do not have to wait for the last sample to come in since we can determine what it should be by the process of elimination rather than sort through the 256/1 samples which would, on the average, be required in order to acquire it. The sample count can be calculated by the formula:

sample count=(256/256+256/255+256/254+256/253+ . . . +256/5+256/4+256/3+256/2)

sample count=1311.832196 for a single array

sample count=671658.084352 for the 131,072 byte PRNS element set

The software which I have written to create PRNS elements of the type discussed here provides statistics regarding their creation. In this instance I caused the software to create ten PRNS element sets (the same PRNS element sets provided in the CDROM appendix), and the software printed this result for the creation session:

(average samples/rotor=1309.08 for 10 files) exiting

Over the ten sets of PRNS elements gathered in this session, we have an average actual sample count of 1309.08, which is within 0.22% of the value predicted by calculation. Experience has shown that with larger numbers of created PRNS element sets this actual reported value gets closer to the calculated theoretical value. This close match between calculated and actual sample counts lends credence to the technique used here to create the PRNS element sets.

Regarding the entropy present in a set of PRNS elements. In creating each of the 256 byte arrays in the set of PRNS elements, we are searching for one occurrence of each one of 256 different byte values arriving in a continuous stream of random bytes. When we start our search with the array completely empty, any byte will be acceptable since we have no bytes on hand as yet and need not worry about duplicates. We are searching for a single byte in a field of 256 entries, and the first byte we receive is always acceptable to us. That byte has a total entropy of 8 bits (256/32) exactly. The second byte we get is selected from a field of only 255 bytes, since we cannot use a byte which duplicates one already in our array. The second byte carries an entropy of only 255/32 or 7.96875 bits. Likewise the third byte we select carries an entropy of only 254/32=7.9375 bits. And so it goes as we fill the 256 byte array, with each byte adding less entropy than the previous byte. The second to last byte we select adds an entropy of only 2/32 bit to our array, and the last byte we select does not add any entropy at all since at this point it has no random component because it's value can be determined by the process of elimination. The total entropy in each 256 byte array of our set of PRNS parameters can be calculated by the formula:

entropy=(256/32+255/32+254/32+253/32+ . . . +4/32+3/32+2/32+0/32)

entropy=1027.96875 bits for a 256 byte array

entropy=128.496+bytes for a 256 byte array

entropy=526,320 bits for the 131,072 byte set of PRNS elements

entropy=65,790 bytes for the 131,072 byte set of PRNS elements

D. Description of one Possible Implementation of Message Encipherment.

Both the encryption and decryption processes use a non-repeating and unique PRNS segment as a One Time Pad. In other sections of this explanation we discuss how sets of PRNS elements are distributed to different users in the network, so this section will be concerned with how existing PRNS generators are kept in synchronization at different stations on the encrypted network.

In this example of encryption, a set of PRNS elements is used to create a unique and non-repeating PRNS segment 2\hat{ }32 bytes in length, and that PRNS segment is used as a One Time Pad for the encryption and decryption of messages. It is convenient but not necessary for each station on the encrypted network to maintain a copy of the entire 4 gigabyte PRNS segment. It is possible for each station on the encrypted network to maintain a copy of the PRNS elements used to create that PRNS segment, and also for each station to create, on an as-needed basis, appropriate portions of that PRNS segment.

For each encrypted message sent out by an sending (encrypting) station, some way of indexing into the 4 gigabyte PRNS segment must be provided, in order to tell the receiving (decrypting) station(s) which portion of the 4 gigabyte PRNS segment to use as the One Time Pad for decrypting the current message. Two methods of providing this index pointer will be discussed here:

1.) Sending along with the message a single 32 bit number which provides a pointer into the PRNS segment.

Advantages:

A.) Brevity—the addition of the 32 bit quantity adds only four bytes to the length of the encrypted message.

B.) Security—this 4 byte quantity does not reveal anything about the internal structure of the PRNS segment currently in use.

Disadvantages:

A.) The receiving station(s) must do one of the following:

1.) Maintain a copy the entire 4 gigabyte PRNS segment.

2.) Create whatever beginning portion of the 4 gigabyte PRNS segment is necessary to take the PRNS generator up to the beginning of the PRNS segment used to decrypt the current message.

3.) Maintain a correlation list to shorten the time needed to create the PRNS segment necessary to decrypt the incoming message. That correlation list would contain entries which match up the received 32 bit number with the entire internal state of the PRNS generator at that given index point.

2.) Sending along with the message a key consisting of the entire state of the PRNS generator at the PRNS step corresponding to the beginning of the message. (This key would amount to the 512 byte ‘window’ string and the dword SALT_VALUE mentioned above.

Advantages:

A.) Savings in time and memory usage—the decrypting station can immediately proceed with the decryption process rather than having to do preliminary stepping through the PRNS in order to arrive at the correct portion of the PRNS segment, and need not maintain in memory either the 4 gigabyte PRNS or the above-mentioned correlating table.

Disadvantages:

A.) Size—the key here amounts to a 512 byte string (the ‘window’ string) and a dword value (SALT_VALUE), and this 516 byte quantity would be added to the message length.

B.) Security—the transmission of the key of the PRNS generator reveals a certain amount of information about the PRNS segment and may be considered to be unacceptable even though the revealed information amounts to only partial information about how a single step of the PRNS segment was created.

Regarding the sending of the actual PRNS generator starting point along with the current message. Given the existence of a default set of PRNS elements and the knowledge of some default technique to encrypt and decrypt the PRNS starting point, it is possible to confidently send the actual PRNS segment starting point (‘window’ and ‘SALT_VALUE’) in encrypted form. In this way, the sending of the PRNS generator starting point (as in 2. directly above) along with a message would give away no information whatsoever regarding the set of PRNS elements used in the encryption of the message.

For further discussion regarding encryption, we will assume that the encrypting station maintains in memory a copy of the entire 4 gigabyte PRNS segment. This 4 gigabyte PRNS segment was created in the past, at the time when the current set of PRNS elements was received by the encrypting station. At the time of the creation of the 4 gigabyte PRNS segment, a 32 bit pointer value having a value of zero was also created. That 32 bit pointer, referred to here as ‘pad_pointer’, serves as an index into the PRNS segment for purposes of encryption—it is incremented every time a byte is encrypted and serves two functions: 1.) It serves as a counter indicating how many bytes have been encrypted with the current PRNS segment, and 2.) It serves as a pointer into the 4 gigabyte PRNS segment. We will assume that pad_pointer is now zero, indicating that we have not yet used the current PRNS segment.

For the sake of discussion, we will use a simple exclusive—or (here referred to as XOR) logic operation as a mixing function to do the actual encryption. It is possible to use one or more of many different schemes to mix the input plaintext with the PAD to form the ciphertext, but here for the sake of simplicity and brevity, we will produce ciphertext by XORing plaintext bytes with bytes from the PAD on a byte-by-byte basis.

One possible encryption technique would proceed like this. This technique assumes several pre-existing entities in memory, specifically these four items:

1.) a buffer of plaintext beginning at address plain_pointer

2.) a counter indicating plaintext size, called plain_count

3.) the buffer of PAD text, beginning at address PAD_pointer

4.) a buffer of ciphertext beginning at address cipher_pointer

In order to encrypt a buffer of plaintext, the instruction sequence might be as follows:

| ; | | |
|---|---|---|
| | mov | esi,offset plain_pointer |
| ;a pointer to the plaintext buffer | | |
| | mov | ebx,offset PAD_pointer |
| ;a pointer to the PAD | | |
| | mov | edi,offset cipher_pointer |
| ;a pointer to the ciphertext pointer | | |
| | mov | ecx,plain_count |
| ;a bytecount, the size of the plaintext | | |
| ; | | |
| crypt: | mov | al, [esi] |

;fetch a byte of plaintext to the AL register

| | |
|---|---|
| mov | bl, [ebx] |

;fetch a byte of PAD to the BL register

| | |
|---|---|
| xor | al,bl |

;perform the exclusive-or encryption

| | |
|---|---|
| mov | [edi],al |

;save the resulting byte of ciphertext

| | |
|---|---|
| inc | esi |

;point at the net byte of plaintext

| | |
|---|---|
| inc | ebx |

;point at the next byte of PAD

| | |
|---|---|
| inc | edi |

;point at the next byte of ciphertext

| | |
|---|---|
| loop | crypt |

;perform loop until plain_count = zero
;

| | |
|---|---|
| mov | esi,offset cipher_pointer |

;on exit, ESI register -> ciphertext buffer, and

| | |
|---|---|
| mov | ecx,plain_count |

;ECX register contains ciphertext bytecount
;
;Software Copyright 1998, 1999, 2000, 2001 by David M. Ross
;Complete software listings are in the CDROM appendix
;

This is a very much simplified version of an encryption routine, and it depends on external routines to do much of the testing necessary for proper and secure operation. At the very least, there must be a mechanism in place to either guard against, or to accommodate the consequences of, beginning an encryption process without sufficient PAD bytes left to complete the process.

E. Description of One Possible Implementation of Message Decipherment which is Interoperable with the Encipherment Technique Described Directly Above. As with the Classic OTP, the Cipher Scheme Described here is Symmetrical and the Decryption Process is very Similar to the Encryption Process. One Possible Decryption Technique would go Like this. This Technique Assumes Several Pre-Existing Entities in Memory, Specifically these Four Items:

1.) a buffer of ciphertext beginning at address cipher_pointer

2.) a counter indicating ciphertext size, called cipher_count

3.) the buffer of PAD text, beginning at address PAD_pointer

4.) a buffer of recovered plaintext beginning at address plain_pointer

In order to decrypt a buffer of ciphertext, the instruction sequence might be as follows:

| ; | | |
|---|---|---|
| | mov | esi,offset cipher_pointer |
| ;a pointer to the ciphertext buffer | | |
| | mov | ebx,offset PAD_pointer |
| ;a pointer to the PAD | | |
| | mov | edi,offset plain_pointer |
| ;a pointer to the plaintext pointer | | |
| | mov | ecx,cipher_count |
| ;a bytecount, the size of the plaintext | | |
| ; | | |
| dcrypt: | mov | al, [esi] |

;fetch a byte of ciphertext to the AL register

| | |
|---|---|
| mov | bl, [ebx] |

;fetch a byte of PAD to the BL register

| | |
|---|---|
| xor | al,bl |

;perform the exclusive-or decryption

| | |
|---|---|
| mov | [edi],al |

;save the resulting byte of recovered plaintext

| | |
|---|---|
| inc | esi |

;point at the net byte of plaintext

| | |
|---|---|
| inc | ebx |

;point at the next byte of PAD

| | |
|---|---|
| inc | edi |

;point at the next byte of ciphertext

| | |
|---|---|
| loop | dcrypt |

;perform loop until cipher_count = zero
;

| | |
|---|---|
| mov | esi,offset plain_pointer |

;on exit, ESI register -> plaintext buffer, and

| | |
|---|---|
| mov | ecx,cipher_count |

;ECX register contains plaintext bytecount
;
;SOFTWARE COPYRIGHT DAVID M. ROSS 2001
;Complete software listings are in the CDROM appendix
;

As above, this is a very much simplified version of a decryption routine, and it depends on external routines to do much of the testing necessary for proper and secure operation. At the very least, there must be a mechanism in place to accommodate the consequences of beginning a decryption process without sufficient PAD bytes left to complete the process (although this exception should surely have been caught at the time of encryption)

F. Description of one Possible Implementation of a Technique used to Transfer PRNS Elements from one Network Station to Another Network Station.

The complete set of PRNS elements is treated as data and sent over the encrypted network as normal encrypted message. The message would have a tag in the message header identifying the message as a set of PRNS elements.

In this implementation, the complete set of PRNS elements has a length of 131076 bytes and carries a checksum as well as the set of PRNS elements. In this implementation, the complete set of PRNS elements has this format:

1.) bytes 1-4 are a dword CRC-32 checksum of the remainder of the set of PRNS elements.

2.) bytes 5-131076 are the actual PRNS elements, consisting of 512 separate but contiguous arrays of 256 bytes each.

Operation of Invention:

The operation of the invention is completely described above but will be repeated here in an abbreviated fashion.

presume a continuous source of truly random data.

hash that source of truly random data, creating a stream of truly random bytes.

operate on that stream of truly random bytes according to the flowchart in FIG. 1, producing a PRNS element set.

use that PRNS element set in concert with a suitable PRNS generator to produce a unique PRNS segment.

check the PRNS segment for repeats.

use that PRNS segment as a one time pad for the encryption and decryption of messages,

since the created PRNS segment is longer than the PRNS element set which was used to create it, it is useful to transfer that PRNS element set over a network as encrypted traffic and use it to re-key other stations on the network.

multiple formats of PRNS generators and PRNS element sets are possible, allowing limits as to interoperability of different logical groups of stations on a network.

Description and Operation of Alternative Embodiments:

Alternate embodiments may take many forms, including but not limited to the following:

The use of alternate formats or different sizes of the PRNS elements or different structures and compositions of the PRNS generator.

The use of alternate forms of PRNS generator, including those types which are not amenable to creation and/or duplication by an end-user.

The use of alternate sources of truly random numbers for the creation of new sets of PRNS elements.

Alternate encryption and decryption schemes may be used, rather than the simple stream XOR cipher used in the examples provided in this application.

The option of absolutely and exhaustively verifying that each set of PRNS elements will produce non-repeating PRNS segments of a certain length.

The option of trusting the reputation of a given PRNS generator to produce non-repeating PRNS segments of a certain length, rather than absolute and exhaustive verification,

All these alternate embodiments should be viewed as trivial changes to the original invention, changes which are certainly encompassed by the claims made below.

Conclusion, Ramifications, & Scope of Invention:

In place of the random number PAD used in the classic Vernam One Time Pad cipher, we use a unique PRNS generator having a high degree of unpredictability. We use only a segment of the generated PRNS which is known, either through reputation or through testing, to not repeat. This unique PRNS segment is used to encrypt messages at the sender's station, and the same unique PRNS segment is used to decrypt messages at the receiver's station.

Along with each encrypted message sent, a ‘key’ into the PRNS segment is sent. This key is in effect a pointer into the PRNS segment and tells the message recipient exactly what portion of the PRNS segment to use in decrypting the message. This key is used to set the receiver's PRNS generator to the same point in it's sequence as was used by the sender. This key amounts to a single pointer into an extremely long PRNS segment, and reveals very little about the sequence. This key is sent along with each encrypted message, but the PRNS element set which are actually used to create the PRNS segment are always kept secret, as is the PAD in the classic OTP cipher.

Since the PRNS segment produced by the PRNS element set is much larger than the actual PRNS element set, the use of a PRNS segment as a PAD allows this OTP cipher variant to be rekeyed over the encrypted link, and does not require a separate and secure path for supplying existing users with additional PAD material as does the classic Vernam OTP cipher.

Other unexpected benefits accrue from the use of a unique PRNS segment as a OTP, such as immunity against security breaches perpetrated upon, and key escrow schemes propagated by, external key distribution methods or Public Key Infrastructures.

What is claimed is:

1. A process for the secure transmission of information over a medium (36), using identical one time pads (28) which are present at a plurality of stations (22) which communicate over said medium, the process comprising the steps of:
(a) providing each said station with a pseudorandom number sequence generator (26) which can generate a pseudorandom number sequence (28) having properties and number sequence programmed and controlled by a replaceable element set (24) which defines and specifies said pseudorandom number sequence;
(b) providing each said station with said replaceable element set, with all of said plurality of stations having identical said replaceable element sets;
(c) allowing each of said plurality of stations to use said pseudorandom number sequence generator and said replaceable element set to generate said pseudorandom number sequence for use as said one time pad;
(d) providing each said station with a mixing technique (30) wherein a plaintext message (34) can be encrypted by means of using said mixing technique to combine said plaintext message and said one time pad; thereby producing a ciphertext message (32) which can be securely transmitted over said medium;
(e) providing each said station with an inverse mixing technique (42) wherein said ciphertext message can be decrypted by means of using said inverse mixing technique to combine said ciphertext message and said one time pad; thereby reproducing the original said plaintext message at any of said plurality of stations.

2. The process of claim 1, if said replaceable element set is shorter than said pseudorandom number sequence and said one time pad, it is useful to securely transmit said replaceable element set over said medium as an encrypted message,
allowing for the creation of multiple alternate pseudorandom number sequences at any of said stations,
and allowing the use of said multiple alternate pseudorandom number sequences as multiple alternate one time pads at any of said stations,
whereby any of said stations can receive said multiple alternate one time pads as encrypted traffic over said medium,
providing said stations with fresh and unique versions of said one time pads without the use of a separate and secure distribution path for said one time pads.

3. The process of claim 1, since said replaceable element set is used with said pseudorandom number sequence generator to produce said pseudorandom number sequence and said one time pad,
and since alternate formats of said replaceable element sets and said pseudorandom number sequence generators can be used,
allowing the creation of multiple logical groups of said stations in which all said stations in each of said logical groups share at least one common said alternate format,
whereby said logical groups can, by design, be allowed access or be denied access to other logical groups.

4. The process of claim 1, since said replaceable element set is used with said pseudorandom number sequence generator to produce said pseudorandom number sequence,
and since the use of differing formats of replaceable element sets and differing formats of pseudorandom number sequence generators will produce pseudorandom number sequences having differing properties of randomness and unpredictability and sequence length,
the creation of pseudorandom number sequences having differing properties of randomness and unpredictability and sequence length is possible by varying the formats of said replaceable element sets and said pseudorandom number sequence generators.

5. The process of claim 1, since said replaceable element set is used with said pseudorandom number sequence generator to produce said pseudorandom number sequence,
and since the pseudorandom number sequence which is produced is a function of the starting point of the pseudorandom number sequence,
it is possible to create multiple pseudorandom number sequences from a single replaceable element set by using different starting points for each of said multiple pseudorandom number sequences.

6. The process of claim 1, wherein said process of secure communication contains the step of sending along with the ciphertext message, a set of state information regarding the internal condition of said pseudorandom number sequence generator at the beginning of the encryption process of said ciphertext message.

7. A process for the secure transmission of information over a medium, wherein a plurality of stations intercommunicate over said medium, where the cipher system used in said secure transmission process uses expendable data resources (52) which are diminished with use, and where one or more of said plurality of stations is an originator station (44) and has available to said originator station a source of truly random data (46), and where said originator station or said originator stations can employ a creation technique (50) to operate on truly random data (48) from said source of truly random data or said sources of truly random data and use said truly random data to create new versions of said expendable data resources, and where;
(d) said originator station or said originator stations can transmit to other said stations, as encrypted traffic over said medium, said new versions of said expendable data resources;
whereby said process of secure transmission of information over said medium can continue and be regenerated depending on only the continued presence of said source of truly random data at said originator station or said originator stations;
and whereby any need for said expendable data resources coming from sources external to said plurality of stations is eliminated.
